(19) United States
(12) Patent Application Publication
(10) Pub. No.: US 2025/0392184 A1
(43) Pub. Date: Dec. 25, 2025

(54) CONNECTION DEVICE FOR ELECTRICALLY AND HYDRAULICALLY CONNECTING HOLLOW CONDUCTORS OF AN INTERNALLY COOLED ELECTRICAL MACHINE

(71) Applicant: dynamic E flow GmbH, Valley (DE)

(72) Inventors: Matthäus Brunner, Poing (DE); Markus Erlacher, Tuntenhausen (DE); Manuel Hartong, Brannenburg (DE); Aleksandar Radakovic, Hohenpeißenberg (DE)

(21) Appl. No.: 18/879,311

(22) PCT Filed: Jun. 26, 2023
(86) PCT No.: PCT/EP2023/067326

§ 371 Date: Dec. 27, 2024

(30) Foreign Application Priority Data
Jul. 1, 2022 (DE) 10 2022 116 519.1

(51) Int. Cl. H02K 3/50; H02K 3/22

(52) U.S. Cl. CPC H02K 3/50; H02K 3/22

(57) ABSTRACT

The invention relates to a connection device (1) for electrically and hydraulically connecting a plurality of electrical hollow conductors (4) of an internally cooled electrical machine. The connection device (1) comprises a connection piece (2), by means of which the hollow conductors (4) can be electrically and hydraulically connected. The connection piece (2) has a plurality of connection points (14) for the attachment of ends of the electrical hollow conductors (4); a hollow interior (15), which is connected to the hollow conductors (4), and an electrical connection point (9) for connecting the hollow conductors (4) to an electrical potential.

According to the invention, an electrically insulating pipe (7) is also provided, which is connected to the connecting piece (2) either directly or by means of an adapter element (6) and which is hydraulically connected to the hollow conductor or hollow conductors (4).

The invention relates to a connection device for the electrical and hydraulic connection of several electrical hollow conductors of an internally cooled electrical machine.

### BACKGROUND OF THE INVENTION

Internally cooled electrical machines with a winding formed from hollow conductors are known from the state of the art. The hollow conductors have a continuous channel through which a coolant is passed in order to cool the electrical machine during operation.

Hollow conductors known from the state of the art are usually in the form of hairpins or pins. The pins or hairpins are usually rigid winding pieces made of copper, which are inserted into slots in the stator of the electrical machine and generate the required magnetic field when the electrical machine is in operation. Another embodiment of internally cooled electrical machines comprises a winding made of thin hollow wire that is wound into coils.

The hollow conductors have open ends through which a coolant can be fed into the hollow conductor or can escape from the hollow conductor. The known hollow conductors are usually provided with an electrically insulating layer on their outer surface.

In the case of internally cooled electrical machines with hollow conductor windings, galvanic isolation of the hydraulic connection from the electrical supply potential poses a particular technical challenge. A known design of a hollow conductor connection piece, in which galvanic isolation is achieved by means of a ceramic ball, is described in EP 3 357 143 A2, for example.

### TASK OF THE INVENTION

It is a task of the present invention to create a connection device for the electrical and hydraulic connection of several electrical hollow conductors of an internally cooled electrical machine, which permits simple galvanic isolation of the hollow conductors from a coolant connection.

This task is solved in accordance with the invention by the features specified in claim 1. Further embodiments of the invention are shown in the sub-claims.

A connection device is proposed for the electrical and hydraulic connection of the electrical hollow conductors of an internally cooled electrical machine, in which the electrical isolation of the hollow conductors from the coolant connection is achieved by a pipe made of an electrically insulating material. The electrically insulating pipe can be, for example, a plastic hose, in particular a Teflon hose, a PEEK capillary or similar.

According to one embodiment of the invention, the connection device comprises a connection piece by means of which the hollow conductors can be connected both electrically and hydraulically, wherein the connection piece:
one or more interfaces for attaching at least one electrical hollow conductor;
a hollow interiorthat communicates with the hollow conductors; and
has anelectrical connection, in particular a connection terminal, for connecting the hollow conductor to an electrical potential.

A connection device according to the invention further comprises an electrically insulating pipeline which is hydraulically connected to the connection piece and the hollow conductor(s).

The pipeline is preferably designed to withstand an internal pressure of at least 60 bar, 80 bar or 100 bar.

The electrically insulating pipe can be connected to the hollow conductor connection piece either directly or by means of an adapter element. In the case of a version with an adapter element, this preferably has a first connection to which the connection piece is connected and a second connection to which the pipe is connected.

The adapter element can be tubular, for example. The adapter element can be made of an electrically insulating material, such as plastic.

In a variant of the invention, the connection piece can comprise a section that is designed as a pipe socket. The electrically insulating pipe can, for example, be connected directly to the pipe socket of the connection piece. In another embodiment with an additional adapter element, the connection piece is detachably attached to the adapter element. In this case, the adapter element can have an opening into which the pipe socket of the connection piece fits.

The connection piece can, for example, have a section with one or more interfaces, in particular openings, for connecting the hollow conductor ends. The openings are preferably dimensioned so that the hollow conductor ends can be inserted into the openings and connected there in a pressure-tight and sealed manner, e.g. by soldering or welding.

According to one variant, the hollow conductor interface of the connection piece can be designed as a separate, plate-shaped element that is integrated into the connection piece in a pressure-resistant and sealed manner, e.g. by soldering or welding.

The connection device according to the invention, including the electrically insulating pipe, is preferably housed in a connection box. The connection box can have one or more electrical connections and one or more coolant connections. To improve the mechanical stability, tightness, etc., the connection device can be partially or fully encapsulated with synthetic resin. The present invention also relates to such a connection box.

The connection piece can be made of an electrically conductive material, such as copper, an insulating material, such as plastic, or a combination of conductive and non-conductive materials.

The connection piece or, if applicable, the adapter element can have an external thread on which one or more nuts are arranged, with the aid of which the component in question can be fastened in or to a housing of the connection box.

The electrical connection piece can, for example, comprise a cable lug to which an electrical phase (U, V, W) can be connected. In principle, any other known type of connection terminal can also be used. An electrical connection is preferably connected to the connection piece with a material connection, e.g. by soldering.

The invention also relates to an internally cooled electrical machine with a hollow conductor winding and a connection device with a pipe made of an electrically insulating material, which galvanically separates the hollow conductors from a central coolant connection.

In the case of a multi-phase electrical machine, a separate connection device is preferably provided for each phase.

### BRIEF DESCRIPTION OF THE DRAWINGS

The invention is explained in more detail below with reference to the accompanying drawings. It shows:

FIG. 1 a sectional view of a connection device for the hollow conductors of an internally cooled electrical machine according to a first embodiment of the invention;

FIG. 2 a sectional view of a connection device for the hollow conductors of an internally cooled electrical machine according to a second embodiment of the invention;

FIG. 3 a perspective view of a connection device for several phases of an internally cooled electrical machine; and

FIG. 4 An example of a connection box for connecting the hollow conductors of an internally cooled electrical machine to the various phases U, V, W and to a coolant circuit.

### EMBODIMENTS OF THE INVENTION

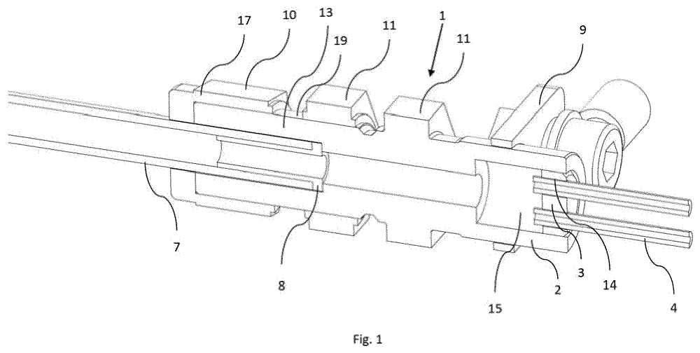

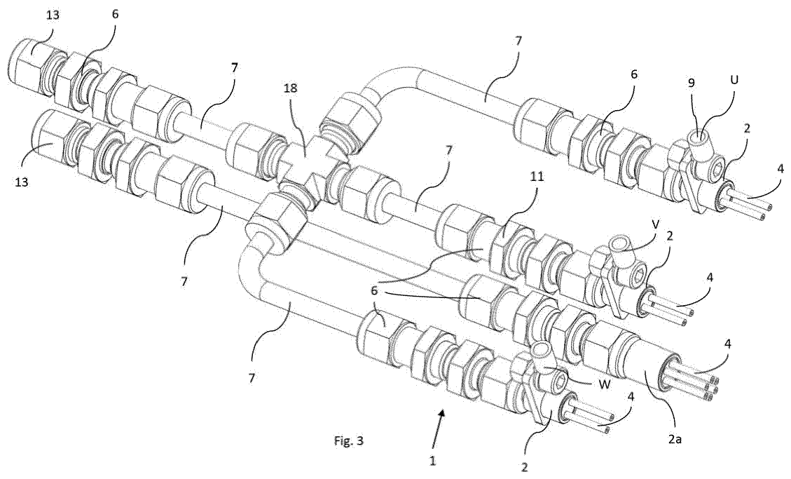

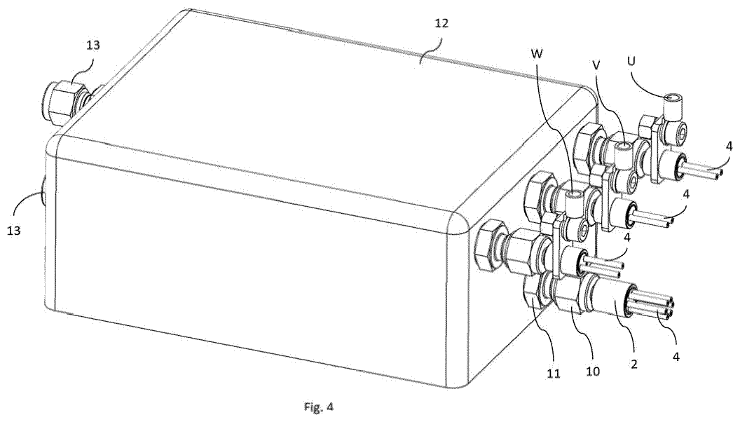

FIG. 1 shows a sectional view of a connection device 1 for the hollow conductors 4 of a winding of an internally cooled electrical machine according to a first embodiment of the invention. The connection device 1 essentially serves to connect the electrical hollow conductors 4 to an associated electrical phase U, V, W and also to connect them hydraulically to a coolant connection 13 (see FIGS. 3, 4).

The connection device 1 comprises a connection piece 2 made of an electrically conductive material, such as copper, to which the hollow conductors 4 are electrically connected, as well as an electrically insulating conduit 7, which is connected to the other side of the connection piece 2. The connection for the conduit 7 is designated by the reference sign 17, and an associated union nut by the reference sign 10.

The electrically insulating pipe 7 is designed as a plastic hose that provides the necessary electrical isolation of the hollow conductor 4 from the hydraulic coolant connection 13. The connection piece 2 has a hollow interior 15, which is hydraulically connected to the hollow conductors 4 and the electrically insulating pipe 7.

In the embodiment shown, the connection piece 2 comprises a connection plate 3 designed as a separate component with several connections 14 in the form of openings for attaching hollow conductor ends. Instead of a separate connection plate 3, the connection piece 2 could also simply have a fastening section with openings for the hollow conductor ends. The connection piece 2 also comprises an electrical connection 9 or a connection terminal for connecting an electrical supply potential (e.g. a phase U, V, W of a three-phase machine). The connection terminal can be designed as a cable lug, for example.

The connection piece 2 also has an external thread 19, on which several nuts 11 are arranged, with which the connection piece 2 can be fastened to the housing of a connection box 12.

The connection device 1 shown offers a particularly simple and cost-effective way of connecting several hollow conductors 4 of an internally cooled electrical machine to an associated electrical phase U, V, W and also connecting them hydraulically to a coolant connection 13.

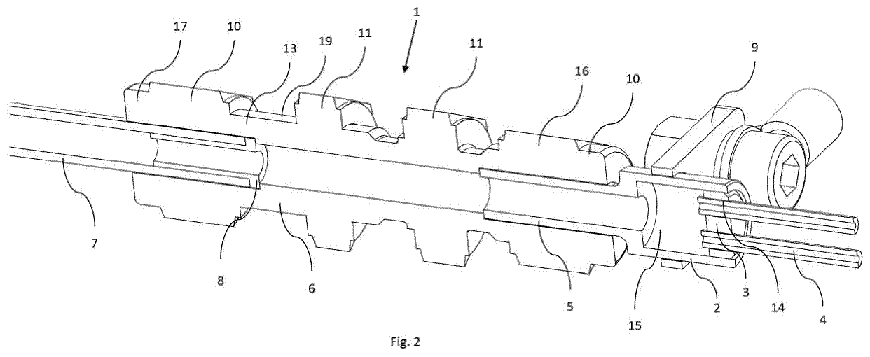

FIG. 2 shows a sectional view of a connection device 1 for the hollow conductor 4 of an internally cooled electrical machine according to a second embodiment of the invention, in which, in contrast to the first embodiment, the electrically insulating conduit 7 is connected to the connection piece 2 via an additional adapter element 6. The adapter element 6 accordingly comprises a first connection 16 for connecting the connection piece 2 and a second connection 17, to which the conduit 7 is connected. Both connections 16, 17 are designed to ensure a tight connection at high pressures. The connections 16, 17 can, for example, be designed as a crimp connection, in particular as a cutting ring connection.

The connection piece 2 has a section designed as a pipe socket 5, to which the electrically insulating pipe 7 is connected. A nut 10 is provided in the area of the first connection 16, which creates a crimp connection between adapter element 6 and connection piece 2. A corresponding nut 10 is also provided at the second connection 17 to connect the plastic tubing 7 to the adapter element 6. In the case of softer plastic hoses, the end of the hose is stabilized there by a pipe insert 8, which is arranged in the plastic hose 7. A tube insert may not be required for rigid plastic hoses.

The adapter element 6 itself can be made of plastic or metal. An external thread 19 can be provided on the circumference of the adapter element 6, on which nuts 11 are arranged, with which the connection device 1 can be fastened to the housing of a connection box 12.

The connection device 1 can be partially or completely encapsulated with synthetic resin. In this case, it is not necessary to attach the connection device 1 to the housing.

FIG. 3 shows a connection device 1 for several phases U, V, W of an internally cooled electrical machine, in which the hollow conductors 4 assigned to a specific phase are each electrically and hydraulically connected to an associated connection piece 2. Each of the connection pieces 2 has an electrical connection terminal 9 for the voltage supply of one phase. The electrical connection terminal 9 is omitted on the connection piece 2a of the neutral point.

The hollow conductors 4 of the individual phases U, V, W are each connected to one of the two hydraulic connections 13 via a separate plastic hose. The hollow conductors 4 assigned to the neutral point (see FIG. 3 lower connection) are connected to the other hydraulic connection 13 via another plastic hose. One of the two hydraulic connections 13 serves as the flow, the other as the return of the cooling circuit. A distributor 18 connects one of the hydraulic connections 13 to the individual connection pieces 2 of the three phases U, V, W.

Finally, FIG. 4 shows an example of a connection box 12 for the electrical and hydraulic connection of the hollow conductor 4 of an internally cooled electrical machine. The connection devices 1 shown in FIG. 2 are located inside the connection box 12 and are attached to the housing of the connection box 12 by means of the nuts 11.

The connections for the hollow conductor 4 of phases U, V, W and the corresponding phase terminals are located on the right-hand side of junction box 12 (top image). The connection for the star point can also be seen at the bottom right of the picture. The flow and return connections 13 of the hydraulic cooling circuit are located on the left-hand side of connection box 12.

1. A connection device for the electrical and hydraulic connection of a plurality of electrical hollow conductors of an internally cooled electrical machine, comprising:
a connection piece with which the hollow conductors can be electrically and hydraulically connected, the connection piece including:
one or more interfaces operably associated with the connection piece and configured to attach ends of the electrical hollow conductor;
a hollow interior communicating with the hollow conductors; and
a section designed as a pipe socket;
an electrical connection operably associated with the connection piece and configured to connect the hollow conductors to an electrical potential,
wherein
an electrically insulating pipe hydraulically connected to the connection piece and the hollow conductor(s); and
an adapter element having a first connection, to which the pipe socket of the connecting piece is connected, and a second connection, to which the electrically insulating pipe is connected, wherein
the first connection and the second connection are designed as a crimp connection.

2. (canceled)

3. The connection device according to claim 1, wherein the pipe is designed as an electrically insulating hose.

4. (canceled)

5. The connection device according to claim 3, wherein the hose is a Teflon hose or a PEEK capillary.

6. The connection device according to claim 1, wherein the connection piece has one or more openings for connecting ends of the hollow conductors or an additional plate-shaped element with one or more openings for connecting ends of the hollow conductors.

7. The connection device according to claim 1, wherein the connecting piece or the adapter element has an external thread.

8. (canceled)

9. The connection device according to claim 1, wherein the hollow conductor includes one or more windings.
